(19) United States
(12) Patent Application Publication
(10) Pub. No.: US 2009/0231157 A1
(43) Pub. Date: Sep. 17, 2009

(54) METER ADAPTOR

(75) Inventor: Stuart Ward, Bournemouth (GB)

Correspondence Address: KLARQUIST SPARKMAN, LLP, 121 SW SALMON STREET, SUITE 1600, PORTLAND, OR, 97204, US

(73) Assignee: Lasermet Limited

(21) Appl. No.: 12/403,165

(22) Filed: Mar. 12, 2009

(30) Foreign Application Priority Data
Mar. 12, 2008 (GB) GB 0804537.9

(51) Int. Cl. G08C 19/16

(52) U.S. Cl. 340/870.01

(57) ABSTRACT

An adaptor can be provided for a meter of the type comprising a meter body and a detector. The meter body can be operative to process and display an analogue output signal generated by the detector indicative of a given input to the detector. The adaptor can comprise electrical connection means operative to form electrical connections with the meter body and with the detector. The adaptor can further comprise interface means operative to convert, in use, the analogue output signal from the detector into a standardised output signal for transmission to the meter body. The interface means can be operative to generate the standardised output signal from a plurality of detectors such that the adaptor can enable the meter body to be used with more than one detector.

### FIELD

The present disclosure relates to an adaptor for a meter of the type, for example, comprising a meter body and a detector.

### BACKGROUND

Meters for the measurement of, for example, laser power, typically comprise a meter body comprising a display unit, a detector being connected to the meter body directly or via a cable. The detector can generate an analogue output signal in dependence upon an input to the detector, the input for example being light or heat although such meters can be used to detect any other desired input. The analogue output signal can be transmitted unprocessed from the detector to the meter body, via the interconnecting cable if provided. The analogue output signal can require processing prior to being displayed on the meter body for viewing by the meter user and this processing can be performed using circuitry inside the meter body, the circuitry being particular to the specific detector being used. It can therefore be difficult to produce a meter body that can be connected to a variety of different sorts of detectors without providing multifunctional circuitry inside the meter body. Such multifunctional circuitry can add significant expense and complexity.

Additionally, if the meter body is to be connectable to a variety of different detectors, processing of the analogue output signal cannot necessarily be easily optimised for each individual detector.

Such prior meters can also be subject to other factors such as noise, interference, signal level, and/or bandwidth for example, which may be affected by sending the unprocessed analogue output signal from the detector to the meter body.

### SUMMARY

According to some embodiments there can be provided an adaptor for a meter of the type comprising a meter body and a detector, the meter body being operative to process and display an analogue output signal generated by the detector indicative of a given input to the detector, the adaptor comprising electrical connection means operative to form electrical connections with the meter body and with the detector, the adaptor further comprising interface means operative to convert, in use, the analogue output signal from the detector into a standardised output signal for transmission to the meter body.

The adaptor can be separate to the detector and meter body.

The interface means can therefore be operative to generate the standardised output signal from a plurality of detectors such that the adaptor enables the meter body to be used with more than one detector.

Alternatively the adaptor can be integral with the detector.

The adaptor can therefore comprise interface means specific to the particular detector.

The interface means can comprise signal processing circuitry operative to process the analogue output signal from the detector.

The signal processing circuitry can comprise analogue and/or digital circuitry.

The connection means of the adaptor can comprise a low voltage DC analogue power supply connection to supply power to the analogue circuitry.

The connection means can comprise a supplementary DC digital power supply connection to supply power to the digital circuitry.

The adaptor can comprise a standard serial digital interface.

The adaptor can include a plurality of chip select lines operative to enable signals from serial digital interface devices in at least one of the adaptor and detector to be transmitted to the meter body.

In some embodiments, at least one of the serial digital interface devices comprises a non-volatile storage chip, such as, for example, an EEPROM.

The non-volatile storage chip can store information selected from the group comprising: detector type identity, calibration information, detector serial number, applicable operating parameters, and meter settings appropriate to the detector.

At least one of the serial digital interface devices can comprise an offset null device.

At least one of the serial digital interface devices can comprise a gain trimming device.

The connection means of the adaptor can comprise at least one analogue channel operative to transmit the standardised output signal from the detector.

The adaptor can be for use with a laser power meter.

According to some embodiments, there can be provided for a meter of the type comprising a meter body and a detector, the meter body being operative to process and display an analogue output signal generated by the detector indicative of a given input to the detector, the meter being provided with an adaptor comprising electrical connection means operative to form electrical connections with the meter body and with the detector, the adaptor further comprising interface means operative to convert, in use, the analogue output signal from the detector into a standardised output signal for transmission to the meter body.

The meter can comprise a power meter.

In some embodiments the meter comprises a laser power meter.

In further embodiments there can be provided a detector adapted to be connected to for a meter of the type comprising a meter body and a detector, the meter body being operative to process and display an analogue output signal generated by the detector indicative of a given input to the detector, the adaptor comprising electrical connection means operative to form electrical connections with the meter body and detector, the detector being provided with an adaptor further comprising interface means operative to convert, in use, the analogue output signal from the detector into a standardised output signal for transmission to the meter body.

Other embodiments can include any combination of the features referred to herein.

The present invention can be carried into practice in various ways, but embodiments will now be described, by way of example only, with reference to the accompanying drawings.

### BRIEF DESCRIPTION OF THE DRAWINGS

FIG. 1 shows a block diagram of an exemplary embodiment of a meter.

FIG. 2 shows a table setting out exemplary connector pin functions for a connector in an adaptor.

### DETAILED DESCRIPTION

Disclosed below are embodiments of meter technologies and/or related systems and methods. The embodiments should not be construed as limiting in any way. Instead, the present disclosure is directed toward all novel and nonobvious features and aspects of the various disclosed methods, apparatus, and equivalents thereof, alone and in various combinations and subcombinations with one another. The disclosed technologies are not limited to any specific aspect or feature, or combination thereof, nor do the disclosed methods and apparatus require that any one or more specific advantages be present or problems be solved.

As used in this application and in the claims, the singular forms “a,” “an” and “the” include the plural forms unless the context clearly dictates otherwise. Additionally, the term “includes” means “comprises.” The phrase “and/or” can mean “one or more of” the elements described in the sentence. Embodiments described herein are exemplary embodiments of the disclosed technologies unless clearly stated otherwise.

Although the operations of some of the disclosed methods and apparatus are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed methods and apparatus can be used in conjunction with other methods and apparatus.

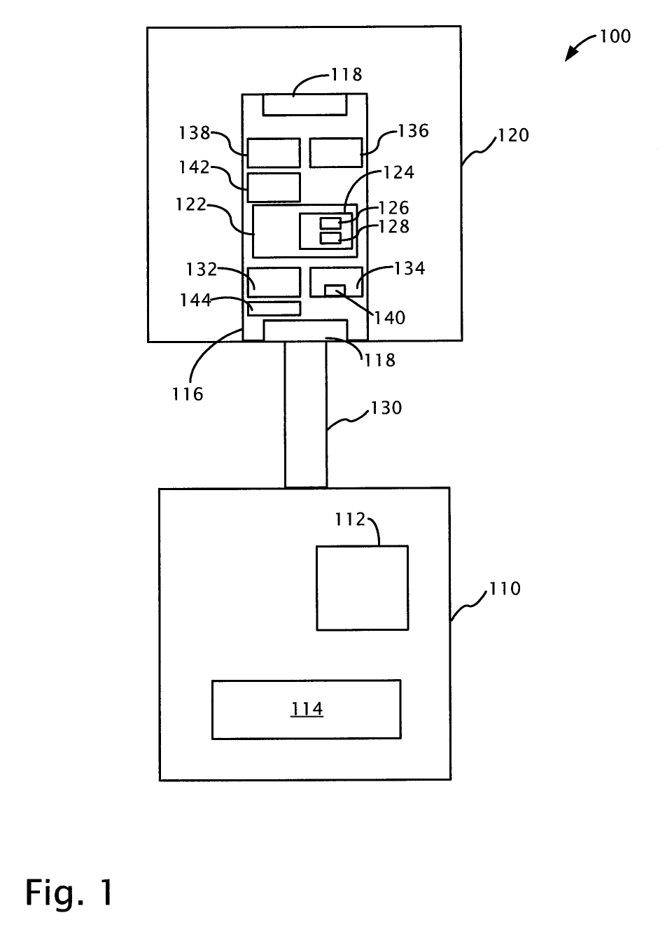

As shown in FIG. 1, one exemplary embodiment of a meter 100, such as a laser power meter for example, comprises a meter body 110 and a detector 120 connected to the meter body via a signal transmitting cable 130. The detector 120 can be operative to generate an analogue output signal indicative of the power of a given input to the detector.

In some embodiments, the meter body 110 comprises meter circuitry 112 to receive and process the output from the detector 120 and to display the processed output as a reading on a display 114 on the meter body 110.

The power meter 100 further comprises an adaptor 116 which in this example is integral with the detector 120. In some embodiments the adaptor 116 is separate from the detector 120.

The adaptor 116 comprises connection means in the form of electrical connectors 118 to enable the adaptor 116 to be connected to both the meter body 110 and the detector 120. The connection between the adaptor 116 and the meter body 110 can be via the signal transmitting cable 130.

In some embodiments, the connection means comprises DVI Standard connectors. The signal transmitting cable 130 can be fitted with male adaptors with male screwlocks at both ends. The meter body 110 and the detector 120 can be fitted with female DVI adaptors with female screwlocks.

The cable connections can be, for example, equivalent to DVI-I single link standard.

In further embodiments, the adaptor 116 comprises interface means in the form of an interface unit 122 comprising signal processing circuitry 124 operative to convert the analogue output signal generated by the detector 120 into a standardised output signal for transmission along the cable 130 to the meter body 110 for processing by the meter circuitry 112 in the meter body 110.

If, for example, the adaptor 116 is separate to the detector 120, the signal processing circuitry 124 can process analogue output signals from a plurality of different detectors.

In some cases, if the adaptor 116 is integrated with the detector 120, the signal processing circuitry 124 can process only the particular analogue output signal from the single detector in question.

The standardised output signal can be such that whatever detector is used, or whatever detector analogue output signal is generated, the meter circuitry 112 can process it; for example, the analogue output signal can be converted into a form that is the same regardless of what input is being detected.

The signal processing circuitry 124 in the adaptor 116 can comprise analogue circuitry 126, digital circuitry 128, or a combination of the two.

The adaptor 116 can include sources of power 132 to operate the analogue processing circuitry 126, the adaptor in this example being inside the detector 120, and +12V and −12V can be provided.

A +5V supply can be also provided to power the digital circuitry. In some cases, the analogue and digital power supplies share a common ground connection.

The adaptor 116 includes a standard serial digital interface 134 comprising, for example, a bi-directional interface (e.g., an interface compliant with the SPI standard), together with one or more chip select lines (e.g., four lines) which can allow serial digital interface devices (such as SPI-interface devices) to be included inside the detector 120. One such device will be a non-volatile storage chip 136 comprising, in this example, an EEPROM which contains the detector identity code to tell the meter 110 which detector 120 is connected. Other information can be stored in the EEPROM including, for example, calibration information, detector serial number, applicable detector operating parameters and meter settings, and other information that can be useful to realise a useful meter.

In further embodiments, other devices that can be included inside the adaptor 116 or detector 120 which utilise the standard serial digital interface 134, can include an offset null device 138 or a gain trimming device 142, according to design.

In particular embodiments, additional digital signals can be included to allow the meter body 110 to control circuitry in the detector 120, e.g., to select amplification ranges, etc.

Logic signals can be, for example, 5V CMOS equivalent.

Analogue signals can be, for example, 0-10V. In at least some cases, the bandwidth will depend on the meter body 110 and detector 120 at each end of the cable 130. The cable 130 and adaptor 116 can be suitable for bandwidths from, for example, DC to 10 MHz. In at least some embodiments, higher bandwidths can be readily achievable.

The adaptor 116 can include one or more analogue output channels 144 from the detector, although in some embodiments only one is generally used. The meter circuitry 112 can be configured to read either input channel.

A Head-OK signal can be included, which can be used to tell the meter circuitry 112 that, for example, a detector is connected and is functioning. In some embodiments, hot-plugging is possible using this signal to detect when a detector is removed or fitted.

In use, the input being detected can be received by the detector 120 and an analogue output signal can be generated. This analogue output signal can be sent to the adaptor 116 and processed by the signal processing circuitry 124 of the interface means of the adaptor 116. The signal processing circuitry 124 converts the analogue output signal into a standardised output signal being an analogue output voltage in the range, for example, 0-10V that can be received, recognised and processed by the standardised meter circuitry 112 in the meter body 110.

In at least some embodiments, the adaptor 116 can thus provide a standardised connection interface between a meter body 110 and a detector 120 such that analogue circuitry dedicated to the specific detector may be incorporated in the adaptor 116, either within or adjacent to the detector 120, the analogue output signal from the detector 120 being converted by the adaptor 116 into a standardised output signal for transmission along the cable 130 to the meter body 110.

In at least some embodiments, the standardised connection interface means that any detector 120 or adaptor 116, which can detect any kind of parameter that it can be desired to measure and which can use different kinds of circuitry, can be connected to existing meter bodies without the need to change the electronic circuitry in the meter body 110.

The detector 120 used need not therefore necessarily be a light measuring detector.

In some embodiments, existing meter bodies 110 can be adapted to operate with the new detector 120 or adaptor 116 by, for example, altering the software algorithm of the meter body 110 to suit the new detector 120 or adaptor 116. In some cases this could be achieved via a PC, for example. In at least some embodiments, one or more components of the adaptor 116 can be configured specifically for (e.g., improved and/or optimised for) a given detector 120.

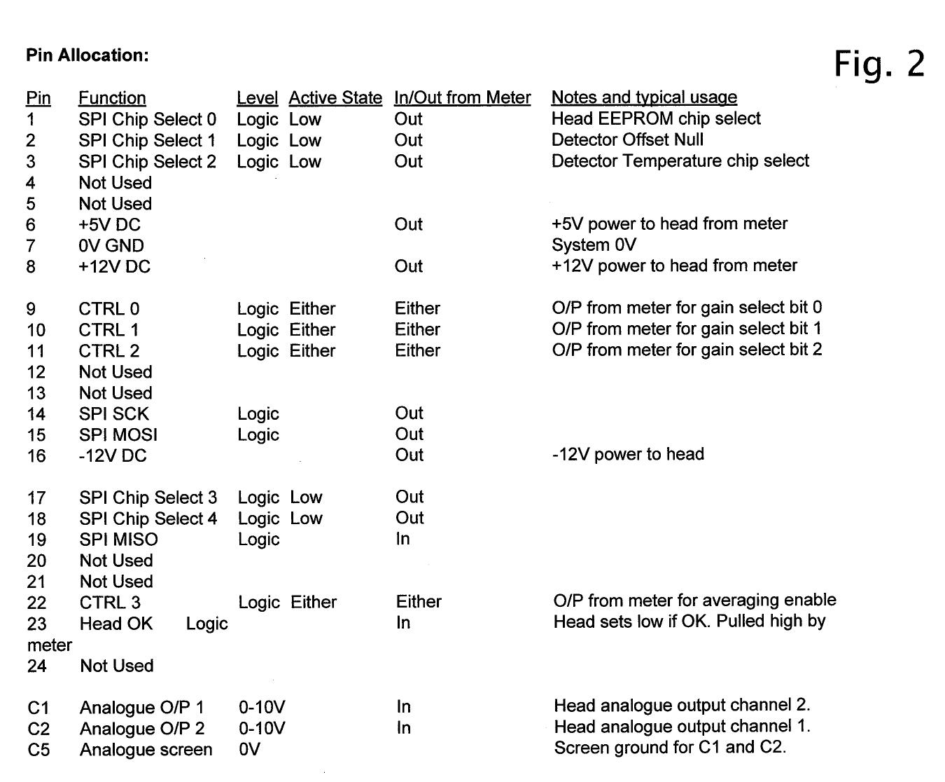

FIG. 2 shows a table setting out exemplary connector pin functions for a connector (e.g., the connection means) in the adaptor 116. Various embodiments can use, for example, one or more additional pin functions, as well as fewer than all of the pin functions shown in FIG. 2.

In view of the many possible embodiments to which the disclosed principles can be applied, it should be recognized that the illustrated embodiments are only examples and should not be taken as limiting in scope. Rather, the scope of protection is defined by the following claims.

I claim:

1. An adaptor for a meter of the type comprising a meter body and a detector, the meter body being operative to process and display an analogue output signal generated by the detector indicative of a given input to the detector, the adaptor comprising electrical connectors operative to form electrical connections with the meter body and with the detector, the adaptor further comprising an interface unit operative to convert, in use, the analogue output signal from the detector into a standardised output signal for transmission to the meter body.

2. The adaptor of claim 1 wherein the adaptor is separate to the detector and meter body.

3. The adaptor of claim 1 wherein the interface unit is operative to generate the standardised output signal from a plurality of detectors such that the adaptor enables the meter body to be used with more than one detector.

4. The adaptor of claim 1 wherein the adaptor is integral with the detector.

5. The adaptor of claim 4 wherein the adaptor comprises an interface unit specific to the particular detector.

6. The adaptor of claim 1 wherein the interface unit comprises signal processing circuitry operative to process the analogue output signal from the detector.

7. The adaptor of claim 6 wherein the signal processing circuitry comprises analogue circuitry.

8. The adaptor of claim 6 wherein the signal processing circuitry comprises digital circuitry.

9. The adaptor of claim 1 wherein at least one of the connectors of the adaptor comprises a low voltage DC analogue power supply connection to supply power to the analogue circuitry.

10. The adaptor of claim 1 wherein at least one of the connectors comprises a supplementary DC digital power supply connection to supply power to the digital circuitry.

11. The adaptor of claim 1 wherein the adaptor comprises a standard serial digital interface.

12. The adaptor of claim 1 wherein the adaptor includes a plurality of chip select lines operative to enable signals from serial digital interface devices in at least one of the adaptor and detector to be transmitted to the meter body.

13. The adaptor of claim 12 wherein at least one of the serial digital interface devices comprises a non-volatile storage chip, such as, for example, an EEPROM.

14. The adaptor of claim 13 wherein the non-volatile storage chip is operative to store information selected from the group comprising: detector type identity, calibration information, detector serial number, applicable operating parameters, and meter settings appropriate to the detector.

15. The adaptor of claim 12 wherein at least one of the serial digital interface devices comprises an offset null device.

16. The adaptor of claim 12 wherein at least one of the serial digital interface devices comprises a gain trimming device.

17. The adaptor of claim 1 wherein the connectors of the adaptor comprise at least one analogue channel operative to transmit the standardised output signal from the detector.

18. The adaptor of claim 1 wherein the adaptor is for use with a laser power meter.

19. A meter of the type comprising a meter body and a detector, the meter body being operative to process and display an analogue output signal generated by the detector indicative of a given input to the detector, the meter being provided with an adaptor comprising electrical connectors operative to form electrical connections with the meter body and with the detector, the adaptor further comprising an interface unit operative to convert, in use, the analogue output signal from the detector into a standardised output signal for transmission to the meter body.

20. The meter of claim 19 wherein the meter comprises a power meter.

21. The meter of claim 20 wherein the meter comprises a laser power meter.

22. A detector adapted to be connected to a meter of the type comprising a meter body and a detector, the meter body being operative to process and display an analogue output signal generated by the detector indicative of a given input to the detector, the adaptor comprising electrical connectors operative to form electrical connections with the meter body and detector, the detector being provided with an adaptor further comprising interface means operative to convert, in use, the analogue output signal from the detector into a standardised output signal for transmission to the meter body.

23. An adaptor for a meter of the type comprising a meter body and a detector, the meter body being operative to process and display an analogue output signal generated by the detector indicative of a given input to the detector, the adaptor comprising electrical connection means operative to form electrical connections with the meter body and with the detector, the adaptor further comprising interface means operative to convert, in use, the analogue output signal from the detector into a standardised output signal for transmission to the meter body.

24. A meter of the type comprising a meter body and a detector, the meter body being operative to process and display an analogue output signal generated by the detector indicative of a given input to the detector, the meter being provided with an adaptor comprising electrical connection means operative to form electrical connections with the meter body and with the detector, the adaptor further comprising interface means operative to convert, in use, the analogue output signal from the detector into a standardised output signal for transmission to the meter body.

25. A detector adapted to be connected to a meter of the type comprising a meter body and a detector, the meter body being operative to process and display an analogue output signal generated by the detector indicative of a given input to the detector, the adaptor comprising electrical connection means operative to form electrical connections with the meter body and detector, the detector being provided with an adaptor further comprising an interface unit operative to convert, in use, the analogue output signal from the detector into a standardised output signal for transmission to the meter body.
